(19) United States
(12) Patent Application Publication
(10) Pub. No.: US 2016/0137346 A1
(43) Pub. Date: May 19, 2016

(54) DRIP FREE GLASS BOTTLES AND METHODS OF MAKING SUCH BOTTLES

(71) Applicant: Brandeis University, Waltham, MA (US)

(72) Inventor: Daniel Perlman, Arlington, MA (US)

(21) Appl. No.: 14/546,470

(22) Filed: Nov. 18, 2014

(51) Int. Cl. B65D 23/06; C03B 23/09; B24B 19/00; B65D 1/02

(52) U.S. Cl. CPC B65D 23/06; B65D 1/023; C03B 23/09; B24B 19/006

(57) ABSTRACT

A glass bottle is configured to improve the mechanics of liquid flow and prevent drip initiation. Additionally, the glass bottle eliminates dripping during pouring to enable drip free pouring. The dripping is prevented over a full range of pouring angles, which vary depending on the amount of liquid held in the glass bottle. A method of making the glass bottle and a method of enabling drip free pouring using the glass bottle are also disclosed.

### FIELD

This technology generally relates to bottles and, more particularly, to drip free glass bottles, methods of making such bottles, and methods of enabling drip free pouring.

### BACKGROUND

When wine is poured from a conventional glass wine bottle, any coating or droplets of wine residing around and beneath the lip of the bottle tend to drip down the outside of the neck and body of the bottle. The amount of unwanted “wine drip” depends on a variety of factors including the pouring angle of the bottle, the rate of pouring, the abruptness of ceasing the pouring, and the shape of the bottle. Dripped wine may stain a table surface or tablecloth onto which the bottle is placed.

Wine drip following pouring is evident with most, if not all, traditionally shaped glass wine bottles such as Bordeaux and Burgundy style wine bottles that are sealed with a cork plug closure. Stelvin-type threaded neck bottles with square-edged lips sealed with a screw cap are also susceptible to dripping, although the wine may be temporarily detoured through the bottle's threads. Some less common bottles containing effervescent wines and ciders as well as beer bottles have lips that differ markedly from traditional wine bottles, i.e., bead-shaped or protruding round lips, but these lips are also susceptible to the dripping problem.

As stated above, when wine is poured from the lip of a traditional glass wine bottle, a portion of the wine almost invariably drips down the outside of the bottle either during pouring or when the bottle is turned upright after pouring. Wine dripping is initiated when a stream of wine that is initially (and usually briefly) falling vertically from the lip of a wine bottle develops a hooked or “curled” flow. The orifice end of many traditional glass wine bottles is molded to form a somewhat curving or dome-shaped, or convex-outward end rather than either a flat or even a concave inward orifice end. Wine flowing over such a dome-shaped orifice end causes the exiting stream to assume the undesired curved flow over the end of the bottle, contributing to drip initiation. The curled flow tends to carry a small amount of the wine backward onto the underside of the bottle's neck and downward toward the heel of the bottle. As the bottle is tilted upright, any wine residing on the underside of the lip dribbles downward over the exterior of the bottle.

It has been found that a full or nearly full bottle of wine is more prone to the dripping problem than a nearly empty bottle. This observation is understood in terms of a changing tilt angle (i.e., angle of elevation of the neck) for a wine bottle being gradually emptied by a person controlling the rate of pouring. Elevation angles (abbreviated EA) for a bottle can be defined and measured from the tilt angle assumed by the “principal axis” of the bottle during pouring of wine from Bordeaux and Burgundy style wine bottles for example. The bottle's “principal axis” (aka, the “center axis”) is defined by a line extending from the center of the heel of the bottle (the bottle's bottom), upward through the bottle's neck in the direction of wine flow.

FIG. 1A shows typical elevation angles for a Bordeaux style wine bottle that is substantially full of wine, i.e., between 80% and 100% of the bottle's liquid capacity remains in the bottle. The level of liquid in the bottles is indicated by a horizontal line. When a bottle is full, a person generally elevates the neck of the bottle relative to the heel of the bottle to regulate the flow of wine from the bottle's orifice. The angle of elevation (EA1) of the bottle measured for the principal axis of the bottle is generally about 15 degrees to provide for controlled pouring. Without such elevation, wine would flow too rapidly from the bottle. The upward tilt of a wine bottle during pouring, however, induces the exiting stream of wine to curve and curl backward onto the underside of the neck surface, initiating wine dripping down the neck of the bottle.

As shown in FIG. 2, for a full bottle of wine being poured with an upward tilt angle of approximately 15 degrees, a droplet of wine exiting the orifice of an unmodified bottle will run “downhill” along the underside of the lip. The dripping problem is only exacerbated after pouring, when the bottle is turned upright. Conversely, when a bottle is nearly empty, i.e. less than 20% of the bottle's liquid capacity remains in the bottle, as shown in FIG. 1B, the neck of the bottle is tilted downward approximately 10 degrees or more.

Droplets of wine on the lip or body of a bottle may not reach the table surface if an absorbent towel or napkin is wrapped around the neck of the bottle before pouring. This approach, however, requires cleaning of the towel or napkin or additional costs for disposable napkins. Alternatively, any of a variety of wine bottle pouring devices may be purchased and attached to a wine bottle and/or its neck opening to control the flow of wine from a bottle. For example, a variety of spouts may be inserted into the neck opening to regulate the flow of wine, aerate the wine, and/or prevent drips. One bottle claiming to be the world's first dripless wine bottle was produced in 1954 by the Roma Wine Company and incorporated a thin edged plastic casing in the neck of the bottle. These solutions, however, all require additional inserts and do not provide for direct pouring from a glass bottle.

Alternatively, many containers used for holding and dispensing liquids have at least one feature to minimize drips, such as a spout that extends the edge of the container outward to facilitate pouring and thereby prevent the last portion of a stream of liquid from running down the sidewall of a container. For example, a glass cream pitcher or a laboratory beaker may include an angled extension of the container's lip that functions as a dripless pouring spout, while a gable-top cardboard milk container may include a fold-out spout that is also dripless. Such a pouring spout on the lip of wine bottle would not be practical as a solution to the dripping problem given the method for sealing the bottle.

### SUMMARY

A method for enabling drip free pouring includes providing a glass bottle including a lip with an inner edge defining a substantially round bottle orifice and a pouring edge. The lip forms a concentric ring around the bottle orifice. A neck cone portion of the bottle extends from the pouring edge of the lip in a conical taper such that an outer diameter of the neck cone portion decreases along at least a portion of the neck cone portion as the neck portion extends from the lip. A major conical angle defined by the conical taper of the neck cone portion ranges from about 30 degrees to about 60 degrees. The pouring edge of the lip has an acute included angle ranging between about 60 degrees and about 75 degrees.

A glass bottle includes a lip comprising an inner edge defining a substantially round bottle orifice and a pouring edge. The lip forms a concentric ring around the bottle orifice. A neck cone portion extends from the outer edge of the lip in a conical taper such that an outer diameter of the neck cone portion decreases along at least a portion of the neck cone portion as the neck cone portion extends from the lip. A major conical angle defined by the conical taper of the neck cone portion ranges from about 30 degrees to about 60 degrees. A junction between the outer edge of the lip and the neck cone portion provides a pouring edge having an acute included angle ranging between about 60 degrees and about 75 degrees.

A method for making a drip-free glass bottle includes forming a lip of a bottle comprising an inner edge defining a substantially round bottle orifice and an outer edge. The lip forms a concentric ring around the bottle orifice. A neck cone portion of the bottle is formed extending from the outer edge of the lip in a conical taper such that an outer diameter of the neck cone portion decreases as the neck cone portion extends from the lip, wherein a major conical angle defining the conical taper of the neck cone portion ranges from about 30 degrees to about 60 degrees and further wherein a junction between the outer edge of the lip and the neck cone portion provides a pouring edge has an acute included angle ranging between about 60 degrees and about 75 degrees.

This technology relates to a bottle that is configured and arranged to improve the mechanics of liquid flow and prevent drip initiation, since few users appreciate a drip when pouring from a bottle. Additionally, this technology advantageously provides a bottle that eliminates dripping during pouring. Further, this technology improves the mechanics of liquid flow from the bottle and prevents drip initiation. The dripping is prevented over a full range of pouring angles, which vary depending on the amount of liquid held in the bottle.

### BRIEF DESCRIPTION OF THE DRAWINGS

FIG. 1A illustrates a typical elevation angle for a standard glass wine bottle that is substantially full of liquid while the liquid is being poured.

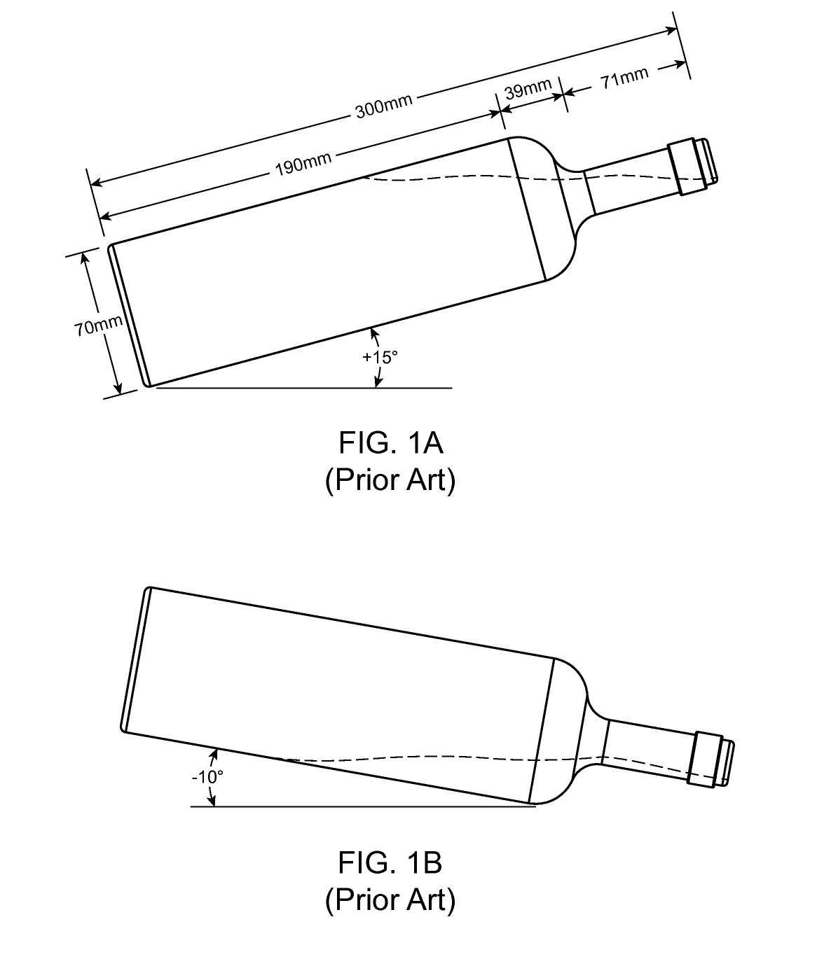

FIG. 1B illustrates a typical elevation angle for a standard glass wine bottle that is nearly empty while the liquid is being poured.

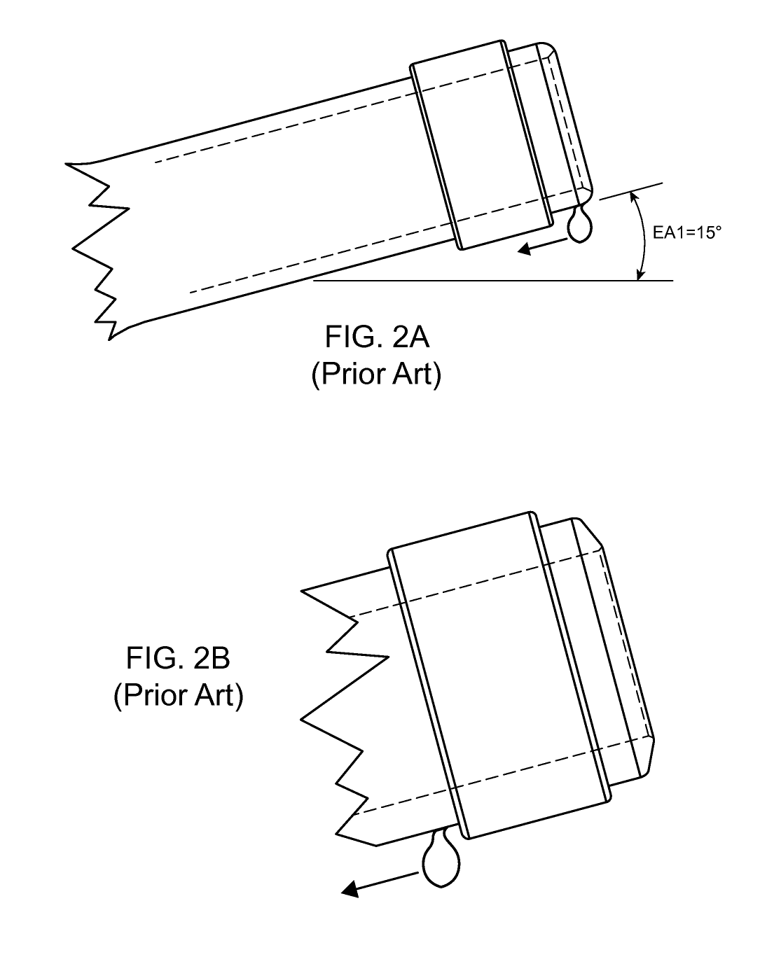

FIG. 2 is a view of the neck portion of a typical Bordeaux or Burgundy style wine bottle in which the neck is oriented with a 15 degree angle of elevation generally used when pouring from a full bottle.

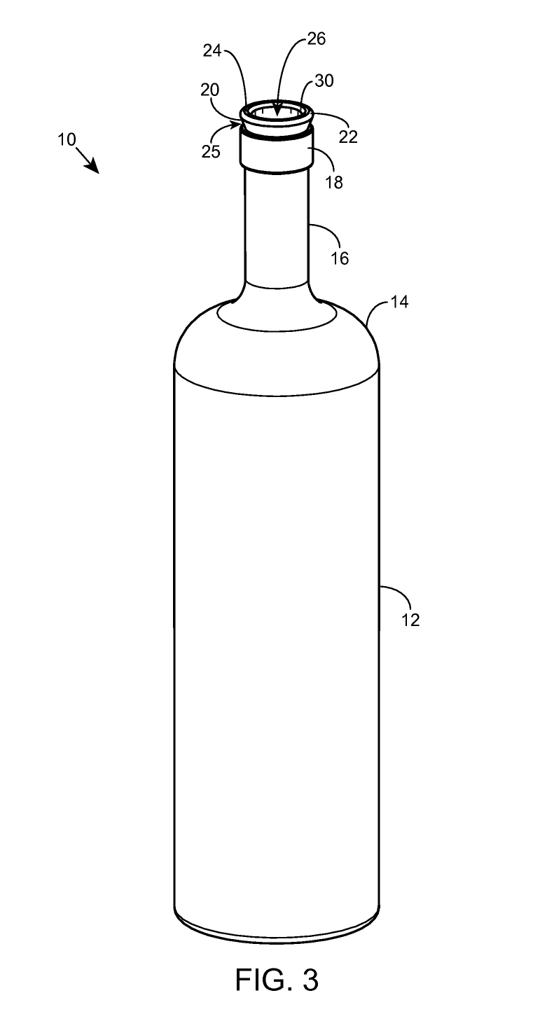

FIG. 3 is a perspective view of an exemplary drip free bottle.

FIG. 4 is a side sectional view of the neck and shoulder portions of the drip free bottle shown in FIG. 3.

FIG. 5 is a side sectional view of the upper neck portion of the drip fee bottle shown in FIG. 3.

FIG. 6 is a side sectional view of the neck portion of the bottle as illustrated in FIG. 4, in which the neck is oriented with a 15 degree angle of elevation generally used when pouring liquid from a substantially full bottle.

### DETAILED DESCRIPTION

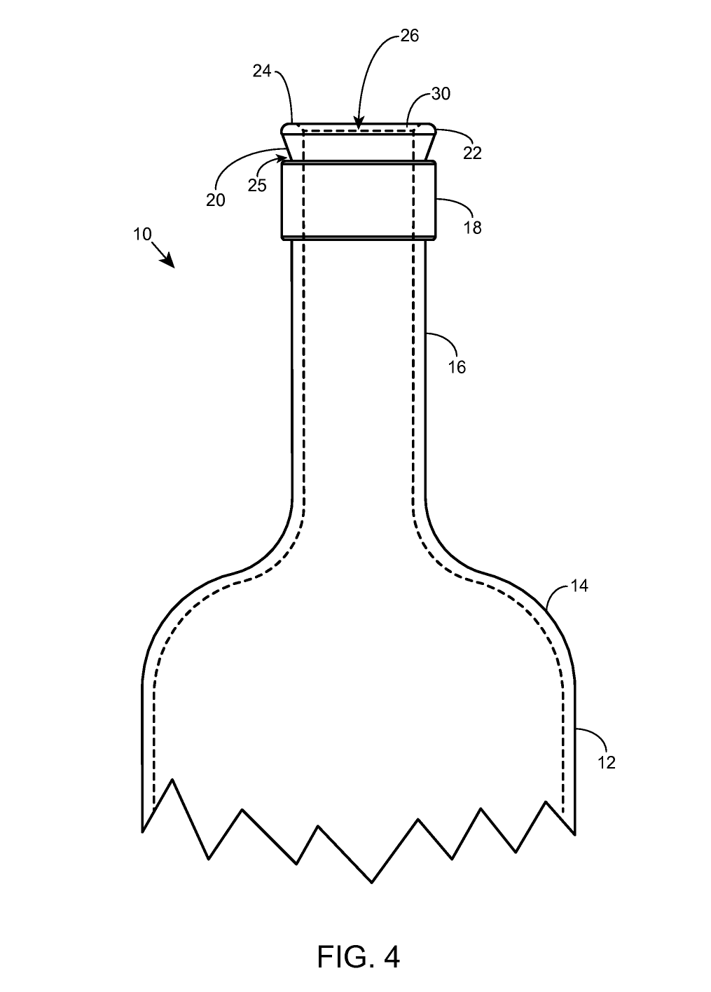

An example of a drip free bottle 10 is illustrated in FIGS. 3-6. The bottle 10 includes a body 12, a shoulder 14, a neck 16, an optional neck collar 18, a neck cone portion 20, a pouring edge 22, a lip 24, and an orifice 26, although bottle 10 may include other parts, elements, and/or features in other configurations. Bottle 10 is formed of glass, although bottle 10 may be formed of other materials. Bottle 10 may be formed using known techniques for forming glass bottles, such as forming the glass bottle from a mold, glass fabrication, or glass blowing. In another embodiment, bottle 10 may be formed from an existing bottle using known techniques such as glass cutting, grinding, or etching, although other known techniques for forming glass bottles may be utilized. Although bottle 10 is shown as a wine bottle, it is to be understood that the exemplary technology of the present invention could be applied to other bottles for which drip free pouring is desirable. This exemplary technology provides a number of advantages including providing drip free pouring over a range of pouring angles without the need for an additional bottle insert or the use of a napkin or other absorbent towel.

Referring more specifically to FIG. 3, the body 12 is configured to house the majority of liquid stored within the bottle 10 and may be sized and shaped, by way of example, as a traditional 750 ml Bordeaux or Burgundy style wine bottle, although other sizes and shapes known in the art of bottle making may be utilized for the body 12. Bottles having larger capacities, such as 400 ml and above, are more susceptible to pouring problems that may be remedied by the present technology. The shoulder 14 provides a taper from the body 12 to the neck 16, although the shoulder 14 may have other configurations.

Neck 16 extends from shoulder 14 to the pouring edge 22 at the junction between neck 16 and lip 24. Neck 16 is sized to receive a friction-fitting plug style closure such as a cork plug for sealing that measures approximately 1 3/4 inches in length and 7/8 inch in diameter for a 750 ml capacity bottle, although other configurations for the neck 16 may be utilized. The neck 16 has an outer diameter of approximately 1.1-1.25 inches, although other diameters may be utilized for the neck 16. Neck 16 is configured with a smooth finished outer surface, although in another embodiment, neck 16 may have a finish with screw threads on an outer surface thereof for receiving a screw cap closure.

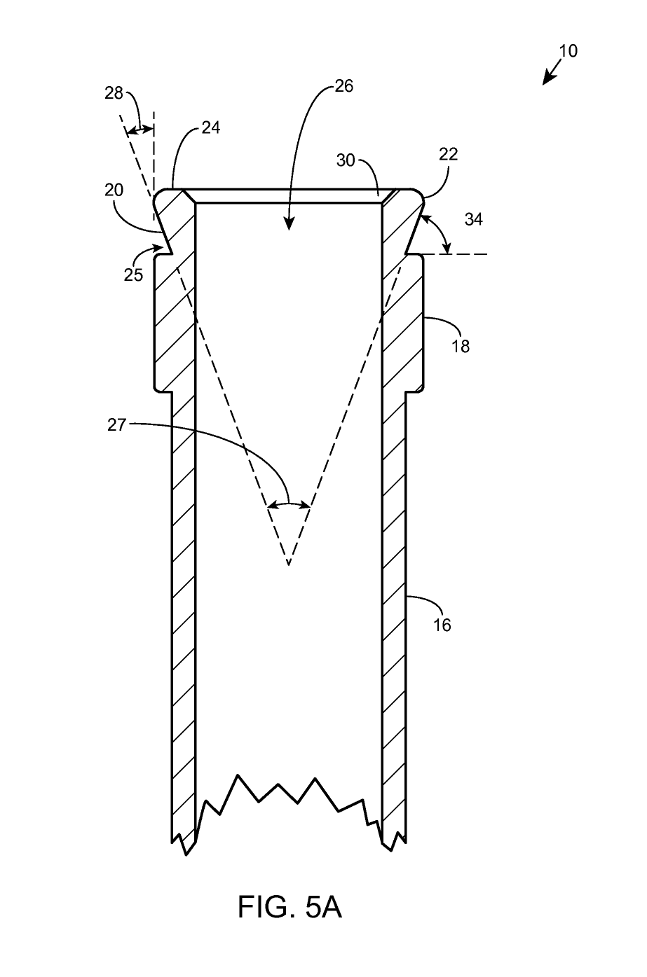

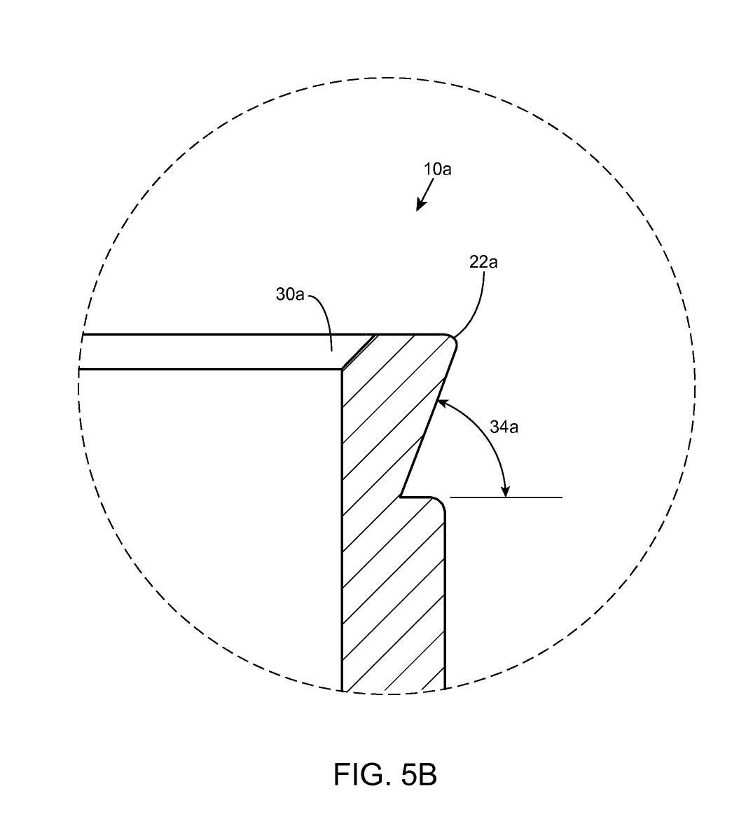

Referring now to FIGS. 4 and 5, the neck 16 includes the neck cone portion 20, which includes the portion of the neck 16 nearest to the pouring edge 22. By way of example, neck cone portion 20 may extend ¼ of an inch to ½ of an inch from the pouring edge 22. Neck cone portion 20 is formed with a tapering conical geometry in which the outer diameter of the neck cone portion 20 decreases along at least a portion of the neck cone portion 20 in a funnel or truncated cone shape to form a drip guard region 25 below the pouring edge 22, although neck cone portion 20 may have other configurations. By way of example, the neck cone portion 20 may have a concave or convex curving slope rather than linear slope. The taper may extend between 3-12 mm along the length of the neck cone portion 20, by way of example.

The acute major conical angle (CA) 27 defined by intersecting tangent lines extended from diametrically opposing sides of the pouring edge 22 along opposing surfaces of the funnel-shaped neck cone portion 20 may range from about 30 degrees to about 60 degrees. In one example, CA 27 ranges from about 40 degrees to about 50 degrees, although CA 27 may range from 30 to 40 degrees, 30 to 50 degrees, 40 to 50 degrees, 40 to 60 degrees, or 50 to 60 degrees. Increasing CA 27 of the neck cone portion 20 to a number greater than 50 degrees or 60 degrees could be, in principle, beneficial in making it more difficult for droplets to bridge the drip guard region 25 on the underside of the lip 24 and initiate dripping during or after pouring. However, a significantly greater value for CA 27 cuts more deeply into the glass forming the wall of the neck 16. A deeper cut might either weaken the neck 16 or make the lip 24 more susceptible to chipping or breakage during removal of a cork plug. While the present disclosure does not exclude values for CA 27 greater than 60 degrees, these greater angles can become counterproductive for the reasons described herein.

Since the CA 27 is measured from tangent lines extending from two diametrically opposing sides of the pouring edge 22, the downward and inwardly tapering or bevel angle 28 on each side of the neck cone portion 20 (from the pouring edge 22 downward) is one-half of the CA 27. For example, with a neck cone portion 20 having a CA 27 value of 40 degrees, the tapering or bevel angle 28 of the neck cone portion 20 is 20 degrees.

The height of the drip guard region 25 formed by the tapering funnel-shaped neck cone portion 20 as measured from the pouring edge 22 to any other structural elements on the neck 16, such as optional neck collar 18, is at least 3 mm. In one example, the height is 3-4 mm, although heights may be utilized such as 3-5 mm, 3-6 mm, 3-7 mm, 4-5 mm, 4-6 mm, 4-7 mm, 5-6 mm, 5-7 mm, or 6-7 mm to create an effective drip barrier. Drip guard region 25 is clear of any interrupting structural elements on the neck 16 that could compromise the effectiveness of the drip guard region 25.

Optional neck collar or neck band 18 may be located around the neck 16 and may serve to strengthen the neck 16. The neck collar 18 is a smooth raised band of glass extending around the circumference of the neck 16. The neck collar 18 may have a length of about 3/8 to 1/2 inch wide (measured top to bottom along the principal axis of the bottle. The neck collar 18 is cast into the glass structure of the uppermost portion of the neck 16, standing in relief above the adjacent surface of the neck 16 approximately 1/16 inch, although neck collar 18 may have other lengths and values for relief above the neck 16. In one example, the edge of the neck collar 18 located proximate the pouring edges is located at least 3-7 mm from the pouring edge 22 to create the necessary clearance for the drip guard region 25 as described above.

Pouring edge 22 is formed by the junction between neck cone portion 20 and lip 24. The acute included angle 34 of the pouring edge 22 ranges from approximately 60 to 75. Larger values for CA 27 that produce smaller (sharper) acute angles 34 at the pouring edge 22 provide greater resistance to dripping.

The radius of curvature of the pouring edge 22 of the bottle 10 is configured to be as small as can be safely used by the user without significantly increasing the risk of glass chipping or breakage. A pouring edge 22 with a smaller radius of curvature is beneficial because it interrupts the flow of liquid more rapidly and abruptly than a pouring edge 22 with a larger radius of curvature when a bottle that is being poured is tilted upright. A larger radius of curvature promotes dripping as liquid being poured curls around the pouring edge and retains residual droplets. A pouring edge 22 with a smaller radius of curvature tends to retain smaller residual droplets than a pouring edge 22 with a larger radius of curvature. This is significant and beneficial because smaller droplets are found less capable of short-circuiting the taper of the neck cone portion 20. However, because a glass pouring edge 22 with a small radius of curvature may be more prone to impact-breakage than a pouring edge with a larger radius of curvature, the radius of curvature at the pouring edge 22 must not be made too small. In one embodiment, the radius of curvature of the pouring edge 22 may be less than 2 mm (1/16 inch=1.6 mm), or less than 1.5 mm, or approximately 1 mm, or approximately 0 5 mm, but should be greater than 0.25 mm. The radius of curvature of the pouring edge 22 can also be approximately 1.5 mm, approximately 1 mm, approximately 0.5 mm, or 0.5 to 2 mm, 1 to 2 mm, 1.5 to 2 mm, 0.5 to 1.5 mm, 1 to 1.5 mm, or 0.5 to 1 mm by way of example only.

The lip 24 extends from the pouring edge 22 to an inner edge 30. The outer diameter of the lip 24 defined by the pouring edge 22 may be approximately 1.05-1.2 inches, although the pouring edge 22 of the lip 24 may have other diameters. The inner edge 30 defines the substantially round bottle orifice 26. In one example, orifice 26 is configured to receive an appropriately sized cork plug. Lip 24 forms a concentric ring around the orifice 26 and is formed as a substantially flat surface. In one embodiment, the curvature and resulting slope measured on the radius of the orifice 26 end of the bottle 10, from the pouring edge 22 inward for lip 24 does not exceed an upward angle of 10 degrees, although other angles may be utilized to provide a substantially flat surface for the lip 24, such as upward slopes ranging from 5 to 10 degrees, 5 to 8 degrees, 3 to 6 degrees, 2 to 4 degrees, 0 to 3 degrees, 0 to 2 degrees, or even 0 to 1 degree. In another embodiment, the slope angle may be approximately zero degrees or even a small negative angle such as a 10 degrees downward slope, such that lip 24 has a concave-inward, or cup-shaped surface.

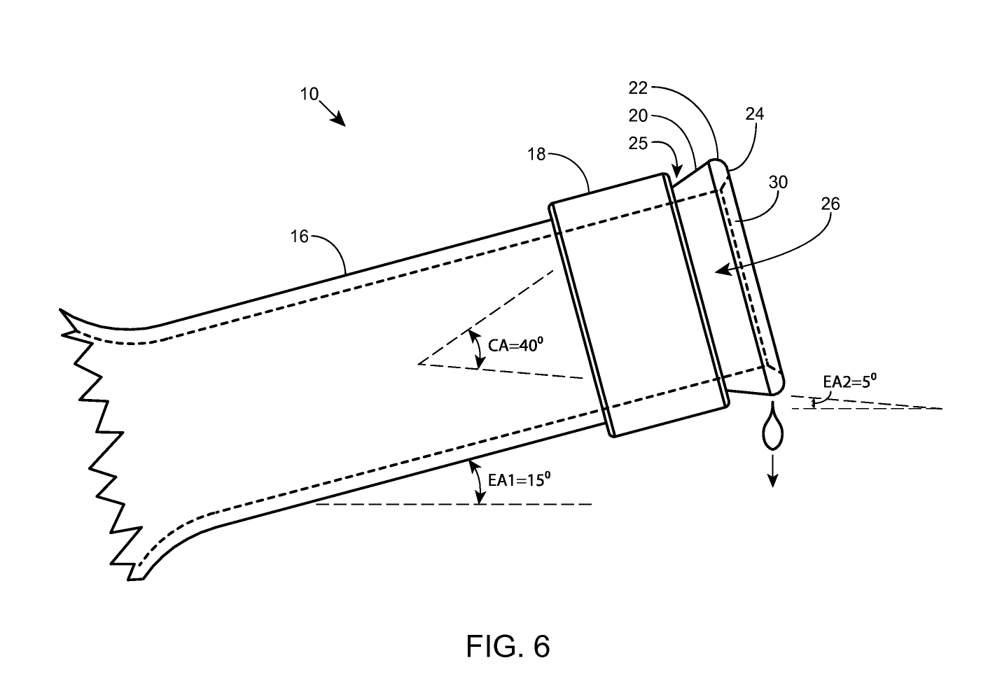

An exemplary operation of bottle 10 will now be described with reference to FIGS. 3-6. As shown in FIG. 6, the neck and shoulder portions of bottle 10 are illustrated with an upward elevation angle (EA1) of 15 degrees representing the typical pouring angle when bottle 10 is substantially full, i.e. 80-100% full. Liquid exiting the bottle flows through orifice 26 at the uppermost end of the neck 16, and then immediately over lip 24 that forms a concentric ring about orifice 26. The substantially flat configuration of lip 24, as described shapes the stream of liquid pouring over the lip 24 and assists in preventing a hooked or curled flow that produces dripping.

The liquid then flows over the pouring edge 22 formed by the junction of the lip 24 and the neck cone portion 20. During pouring, the pouring edge 22 facilitates directed flow of the liquid into a receptacle and also functions to interrupt and break the flow of liquid when the bottle is tilted upright, while also reducing the size of droplets that can cling to the lip 24 before falling into a glass. In this example, the acute included angle 34 formed by the pouring edge 22, which is equal to 90−½ x the conical angle described and defined above is 70 degrees, i.e., (90−½×40), although angle 34 may range from 60 degrees to approximately 75 degrees.

In the example shown in FIG. 6, the neck cone portion 20 has a conical taper that forms a CA 27 of 40 degrees, although other values for CA 27 may be utilized as set forth above. Due to the taper of the neck cone portion 20, droplets being poured over the pouring edge 22 tend to move with the force of gravity away from the neck cone portion 20 in the direction of the pour, as opposed to curling about the edge of the neck 16. The net 5 degree downward elevation angle (EA2) of the lip 24 relative to the horizon represents the difference between the 20 degree downward bevel angle 28 formed by pouring edge 22 (½ of the conical angle of 40 degrees) and the upward elevation angle (EA1) of 15 degrees relative to the horizon for pouring from a full bottle, such as wine. The 5 degree downward angle encourages droplet flow towards the pouring edge 22 and away from the neck cone portion 20.

The tapered configuration of neck cone portion 20 further provides the drip guard region 25, which helps to prevent the propagation of drips along the surface of the neck 16. Accordingly, the upper side edge of the optional neck collar 18, or any other structural element located on neck 16, is at least 4 mm or even 5 mm, 6 mm or 7 mm distant from, i.e., below, the pouring edge 22 to assure that an adequate buffer zone is provided. During pouring from a full bottle as shown in FIG. 6, the conical taper of neck cone portion 20 provides the drip guard region 25 that prevents liquid (as a stream or droplets) from coating and short-circuiting the drip guard region 25 to cause dripping. To provide that effective buffer zone, the uninterrupted vertical height of the drip guard region 25 is approximately 4-7 mm, and extends up to the pouring edge 22.

Accordingly, as illustrated and described by way of the examples herein, this technology involves structural modifications to the neck cone portion and lip of a bottle. In particular, the modified portions of the bottle's architecture in these examples include those structural elements in the neck cone portion contacted by liquid during pouring or within approximately ½ inch of such flowing liquid.

Further by way of example, these modifications include: (1) adding an acutely angled pouring edge (with a limited radius of curvature) to the lip portion of the bottle, and (2) introducing a new “drip guard” architecture that replaces the cylindrical uppermost portion of the neck (up to the lip) with a tapered funnel-shaped form (geometrically, a truncated cone form). With this technology, the conically shaped uppermost portion of the neck lies immediately below the pouring edge of the lip. In these examples, the pouring edge is created by the junction of: (a) a substantially flat and horizontal lip surface on the top of the bottle and (b) an uppermost neck portion whose exterior is formed in the shape of a tapering upright funnel.

### EXAMPLE

### Fabrication and Testing of Drip Function

In order to test drip function, glass wine bottle lips were crafted by mechanically grinding the uppermost neck and lip portions of conventional glass wine bottles using a rotating water-cooled silicon carbide grinding wheel with subsequent polishing. Six commercial glass wine bottles (750 ml “Semeru” Burgundy style bottles) were then obtained from M.A. Silva USA Inc. (Santa Rosa, Calif.). The neck finishes of these bottles were modified by grinding and polishing the glass to test and compare different potential drip-free wine bottle architectures. Each bottle was mounted horizontally and secured in a motorized device that rotated the bottle slowly. A water-cooled silicon carbide grinding wheel was then brought into contact with each portion of the neck finish to be altered. Ground glass surfaces were subsequently polished until smooth and glossy (finished with white rouge polishing compound) to replicate the surface of a glass bottle made from a mold.

Four structural elements within the uppermost neck and lip portions of a bottle's neck finish were tested. These structural elements and their dimensions (in millimeters unless otherwise stated) are provided in Table 1. Their description (and identifying abbreviations used in Table 1) are as follows:

(a) Major conical angle (CA, measured in degrees) defined by intersecting tangent lines extended from diametrically opposing sides of the pouring edge along opposing surfaces of the funnel-shaped neck cone portion.

(b) Drip guard (DripG) length measured from the pouring edge of the lip downward to the upper edge of the neck collar,

(c) Shape of the lip surrounding the bottle's orifice, i.e., convex/dome-shaped (Dome) or ground flat (Flat)

(d) Radius of curvature of the pouring edge on the bottle's lip (Lip Radius)

TABLE 1

| | Bottle Number | | | | | |
|---|---|---|---|---|---|---|
| | 1 | 2 | 3 | 4 | 5 | 6 |
| CA (angle) | (0° control) | 30° | 30° | 40° | 50° | 60° |
| DripG (length) | 0 mm | 5 mm | 6 mm | 3 mm | 3 mm | 5 mm |
| Lip Shape | Dome | Dome | Flat | Dome | Flat | Flat |
| Lip Radius | 2 mm | 2 mm | 1 mm | 2 mm | 1 mm | 1 mm |

Wine was repeatedly poured from each of the six bottles with their neck finishes modified as described above. The extent to which each fully filled wine bottle (containing 750 ml wine) experienced dripping during wine pouring was monitored. The “control bottle” (unmodified bottle #1) showed extensive and repeated dripping as wine coating the lower surface of the bottle from the lip downward to the heel of the bottle during nearly each pouring. Bottle #2 showed less dripping than #1, but the dome-shaped top contour of the bottle allowed the exiting stream of wine to curl backwards beneath the lip, often far enough to contact the upper edge of the neck collar and thereby initiate dripping. Bottle #3 rarely showed dripping, and with a frequency much lower than bottle #2, with the flat top contour of bottle #3 allowing the exiting stream of wine to fall straight downward from the lip's pouring edge without curling backwards. Bottle #4, with its dome-shaped top contour, showed the same wine flow problem observed with bottle #2, and drip initiation occurred frequently but less frequently than #1. Bottles #5 and #6 showed no dripping whatsoever during pouring. Again, their flat top contours allowed the exiting wine to fall straight down off the pouring edge of the lip, thereby avoiding the wine stream curl-back problem (seen with bottles #1, #2, and #4) that usually initiates dripping when the underside of the lip and neck are wetted with wine.

Accordingly, this technology provides a method of enabling drip free pouring, a drip free bottle, and methods of making the bottle that advantageously allow for drip free pouring, without the need for an additional insert into the bottle. Additionally, the bottle may be produced for approximately the same cost as standard bottles. Further, the bottle provides the drip free pouring over a full range of pouring angles.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Accordingly, the technology is limited only by the following claims and equivalents thereto.

1. A method for enabling drip free pouring comprising:
providing a glass bottle comprising a lip extending from an inner edge defining a substantially round bottle orifice to a pouring edge, wherein said lip forms a concentric and substantially flat ring around and perpendicular to the bottle orifice and a neck cone portion of the glass bottle extends from the pouring edge of the lip in a conical taper such that an outer diameter of the neck cone portion decreases along at least a portion of the neck cone portion as the neck portion extends from the lip, wherein a major conical angle defined by the conical taper of the neck cone portion ranges from about 30 degrees to about 60 degrees, and further wherein the pouring edge of the lip has an acute included angle ranging between about 60 degrees and about 75 degrees and comprises a radius of curvature of between about 0.25 mm and 2.0 mm; and wherein the glass bottle further comprises at least one of: (i) an interior surface of a neck configured to be sealed with a cylindrical plug style closure and (ii) a neck collar extending outward from an outer surface of the neck and having an upper edge located proximate to the pouring edge of the bottle, wherein a drip guard angle defined by the upper edge of the neck collar and the outer surface of the neck is less than 90 degrees.

2. The method of claim 1, wherein the concentric ring formed by the lip is between approximately 2 mm and 5 mm wide.

3. (canceled)

4. The method of claim 1, wherein the substantially flat lip comprises a convex curvature of less than 10 degrees.

5. The method of claim 1, wherein the substantially flat lip comprises a concave curvature of less than 10 degrees.

6. The method of claim 1, wherein the conical taper of the neck cone portion extends between 3 mm and 12 mm from the pouring edge of the lip.

7. (canceled)

8. The method of claim 1, wherein the bottle comprises a capacity greater than at least 400 mL.

9. A glass bottle comprising:
a lip extending from an inner edge defining a substantially round bottle orifice to a pouring edge, wherein said lip forms a concentric and substantially flat ring around and perpendicular to the bottle orifice; and
a neck cone portion of the glass bottle extending from the pouring edge of the lip in a conical taper such that an outer diameter of the neck cone portion decreases along at least a portion of the neck cone portion as the neck portion extends from the lip, wherein a major conical angle defined by the conical taper of the neck cone portion ranges from about 30 degrees to about 60 degrees, and further the pouring edge of the lip has an acute included angle ranging between about 60 degrees and about 75 degrees and comprises a radius of curvature of between about 0.25 mm and 2.0 mm; and
wherein the glass bottle further comprises at least one of: (i) an interior surface of a neck configured to be sealed with a cylindrical plug style closure and (ii) a neck collar extending outward from an exterior surface of the neck cone portion and having an upper edge located proximate to the pouring edge of the bottle, wherein a drip guard angle defined by the upper edge of the neck collar and the exterior surface of the neck cone portion is less than 90 degrees.

10. The bottle of claim 9, wherein the concentric ring formed by the lip is between approximately 2 mm and 5 mm wide.

11. (canceled)

12. The bottle of claim 9, wherein the substantially flat lip comprises a convex curvature of less than 10 degrees.

13. The bottle of claim 9, wherein the substantially flat lip comprises a concave curvature of less than 10 degrees.

14. The bottle of claim 9, wherein the conical taper of the neck cone portion extends between 3 mm and 12 mm from the pouring edge of the lip.

15. (canceled)

16. The bottle of claim 9, wherein the bottle comprises a capacity of greater than at least 400 mL.

17. A method for making a drip-free glass bottle comprising:
forming a lip extending from an inner edge defining a substantially round bottle orifice to a pouring edge, wherein said lip forms a concentric and substantially flat ring around and perpendicular to the bottle orifice; and
forming a neck cone portion of the glass bottle extending from the pouring edge of the lip in a conical taper such that an outer diameter of the neck cone portion decreases as the neck cone portion extends from the lip, wherein a major conical angle defining the conical taper of the neck cone portion ranges from about 30 degrees to about 60 degrees and further wherein the pouring edge of the lip has an acute included angle ranging between about 60 degrees and about 75 degrees and comprises a radius of curvature of between about 0.25 mm and 2.0 mm; and forming at least one of (i) an interior surface of a neck of the glass bottle, said interior surface configured to be sealed with a cylindrical plug style closure and (ii) a neck collar of the glass bottle, said neck collar extending outward from an exterior surface of the neck cone portion and having an upper edge located proximate to the pouring edge of the bottle, wherein a drip guard angle defined by the upper edge of the neck collar and the exterior surface of the neck cone portion is less than 90 degrees

18. The method for claim 17, wherein the concentric ring formed by the lip is between approximately 2 mm and 5 mm wide.

19. (canceled)

20. The method for claim 17, wherein the substantially flat lip comprises a convex curvature of less than 10 degrees.

21. The method for claim 17, wherein the substantially flat lip comprises a concave curvature of less than 10 degrees.

22. The method for claim 17, wherein the conical taper of the neck cone portion extends between 3 mm and 12 mm from the pouring edge of the lip.

23. (canceled)

24. The method of claim 17, wherein the bottle comprises a capacity of greater than at least 400 mL.

25. The method of claim 1, wherein the pouring edge comprises a radius of curvature between about 0.25 mm and about 1.0 mm.

26. The method of claim 25, wherein the pouring edge comprises a radius of curvature between about 0.5 mm and about 1.0 mm.

27. The method of claim 1, wherein the bottle is a wine bottle.

28. The bottle of claim 9, wherein the pouring edge comprises a radius of curvature between about 0.25 mm and about 1.0 mm.

29. The bottle of claim 28, wherein the pouring edge comprises a radius of curvature between about 0.5 mm and about 1.0 mm.

30. The bottle of claim 9, wherein the bottle is a wine bottle.

31. The method of claim 17, wherein the pouring edge comprises a radius of curvature between about 0.25 mm and about 1.0 mm.

32. The method of claim 31, wherein the pouring edge comprises a radius of curvature between about 0.5 mm and about 1.0 mm.

33. The method of claim 17, wherein the bottle is a wine bottle.

34. The method of claim 1, wherein the glass bottle comprises an interior surface of a neck configured to be sealed with a cylindrical plug style closure.

35. The bottle of claim 9, wherein the glass bottle comprises an interior surface of a neck configured to be sealed with a cylindrical plug style closure.

36. The method of claim 17, wherein the glass bottle comprises an interior surface of a neck configured to be sealed with a cylindrical plug style closure.

37. The method of claim 1, wherein the glass bottle comprises a neck collar extending outward from an exterior surface of the neck cone portion and having an upper edge located proximate to the pouring edge of the bottle, wherein a drip guard angle defined by the upper edge of the neck collar and the exterior surface of the neck cone portion is less than 90 degrees.

38. The bottle of claim 9, wherein the glass bottle comprises a neck collar extending outward from an exterior surface of the neck cone portion and having an upper edge located proximate to the pouring edge of the bottle, wherein a drip guard angle defined by the upper edge of the neck collar and the exterior surface of the neck cone portion is less than 90 degrees.

39. The method of claim 17, wherein the glass bottle comprises a neck collar extending outward from an exterior surface of the neck cone portion and having an upper edge located proximate to the pouring edge of the bottle, wherein a drip guard angle defined by the upper edge of the neck collar and the exterior surface of the neck cone portion is less than 90 degrees.
